(19) United States
(12) Patent Application Publication
(10) Pub. No.: US 2003/0186117 A1
(43) Pub. Date: Oct. 2, 2003

(54) Primary lithium battery and method of forming the same

(75) Inventors: Frough K. Shokoohi, Kirtland, OH (US); Xuekun Xing, Richmond Heights, OH (US)

Correspondence Address: MARK KUSNER COMPANY LPA, HIGHLAND PLACE SUITE 310, 6151 WILSON MILLS ROAD, HIGHLAND HEIGHTS, OH, 44143

(73) Assignee: NTK Powerdex, Inc.

(21) Appl. No.: 10/108,578

(22) Filed: Mar. 27, 2002

(51) Int. Cl. H01M 2/02

(52) U.S. Cl. 429/162; 429/127; 429/326; 29/623.5

(57) ABSTRACT

A primary lithium battery, comprised of a battery package formed from a thin metal/polymer laminate and a single, elongated battery cell having a cathode section, an anode section and a separator disposed between the cathode section and the anode section. The cathode section includes a copper foil having a cathode film thereon. The cathode film includes manganese dioxide, carbon, a polymer binder and a plasticizer, the plasticizer consisting of propylene carbonate (PC). The anode section includes a copper foil having a lithium foil thereon. The battery is folded within the battery package and an electrolyte including propylene carbonate (PC), ethylene carbonate (EC) and a lithium salt are contained within the battery package.

### FIELD OF THE INVENTION

The present invention relates generally to batteries, and more particularly to a thin, primary battery and a method of forming the same.

### BACKGROUND OF THE INVENTION

Improvements in microelectronics have increased the demand for electrolytic cells and batteries that can power electronic devices so as to produce a portable, finished package. As the improvements in microelectronics reduce the size of the electronic device, the space allotted to a power supply within such device has likewise decreased. It is therefore important to maximize the power-per-unit space that a battery cell can provide.

For extremely thin or unusually shaped batteries, flexible packaging has found advantageous applications. Flexible packaging can provide hermetic containment of the battery. In addition, flexible materials are lighter thus providing a lighter weight battery of the same energy or higher energy per gram.

The advantages of flexible laminate packaging are particularly valuable for small, high-energy batteries. In general, the smaller the battery becomes in any one dimension, the greater is the contribution of the packaging to the overall power per unit weight and/or power per unit volume of the battery.

The present invention relates to a thin, prismatic, primary lithium battery that is packaged in a thin, metal, polymer laminate material, and a method of forming the same.

### SUMMARY OF THE INVENTION

In accordance with a preferred embodiment of the present invention, there is provided a primary lithium-ion battery, comprised of a battery package formed from a thin metal/polymer laminate and a single, elongated battery cell having a cathode section, an anode section and a separator disposed between the cathode section and the anode section. The cathode section includes a copper foil having a cathode film thereon. The film includes manganese dioxide, carbon, a polymer binder and a plasticizer selected from the group consisting of propylene carbonate (PC). The anode section includes a copper foil having a lithium foil thereon. The battery is folded in an accordion fashion within the battery package or wound around a rectangular thin mandrel, and an electrolyte including propylene carbonate (PC) is contained within the battery package.

In accordance with another aspect of the present invention, there is provided a method of forming a primary lithium-ion battery, comprising the steps of: forming an elongated, rectangular battery cell strip having leads extending therefrom by joining an elongated strip of a cathode section to an elongated anode section with an elongated sheet of separator material disposed therebetween, the cathode section being comprised of a metallic foil having a cathode film thereon; folding the battery cell strips in accordion fashion, or wound in a prismatic format, to form a generally rectangular structure; inserting the folded battery cell into a rectangular cavity formed in a first sheet of laminate material with the battery lead extending from the cavity; covering the battery and cavity with a second sheet of the laminate material and sealing the edges of the first and second sheets of laminate material to encase the battery therein.

It is another object of the present invention to provide a thin, primary lithium battery.

It is another object of the present invention to provide a primary lithium battery as described above having a thin, polymer cathode film containing an organic solvent or a liquid electrolyte as a plasiticizer.

Another object of the present invention is to provide a primary lithium battery as described above that is packaged within a thin, metal laminate packaging material.

A still further object of the present invention is to provide a primary lithium battery as described above that is packaged in a “butter-cup” type package.

A still further object of the present invention is to provide a method of forming a battery as described above.

These and other objects will become apparent from the following description of a preferred embodiment of the invention, taken together with the accompanying drawings.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is an exploded view of a battery, illustrating a preferred embodiment of the present invention;

FIG. 2 is an enlarged view of one end of a battery cell showing battery leads extending therefrom;

FIG. 3 is a cross-sectional view taken along lines 3-3 of FIG. 2;

FIG. 4 is a sectional view through a battery showing the arrangement of the battery cell therein;

FIG. 5 is a partially sectioned top plan view of a cathode section used to form the battery shown in FIG. 1;

FIG. 6 is a partially sectioned top plan view of an anode section used to form the battery shown in FIG. 1;

FIG. 7 is a schematic representation of a process for forming the cathode section shown in FIG. 5; and

FIG. 8 is a schematic representation of a process for forming the anode section shown in FIG. 6.

### DETAILED DESCRIPTION OF PREFERRED EMBODIMENT

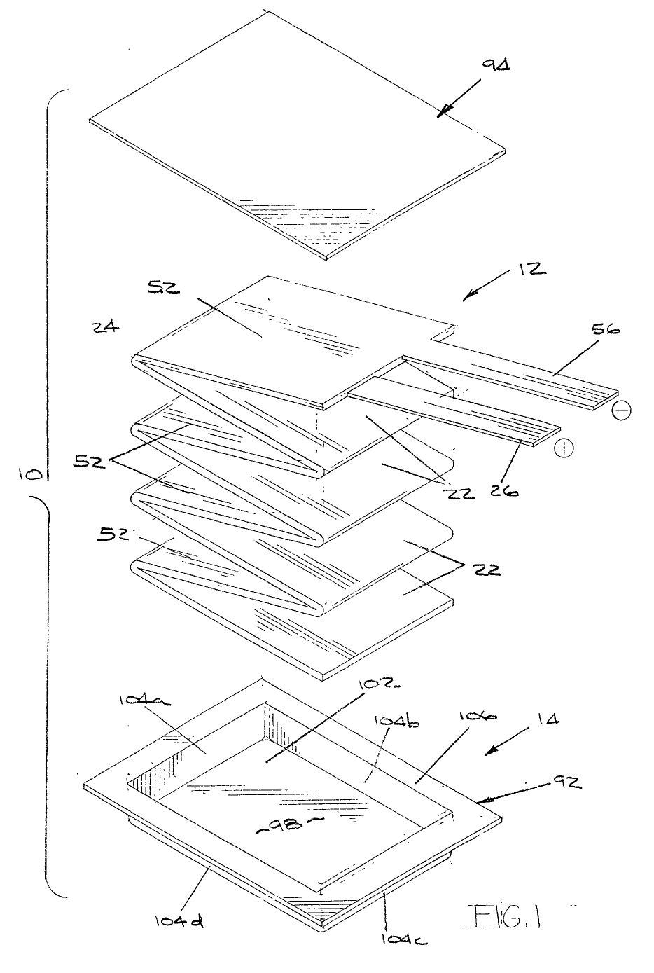

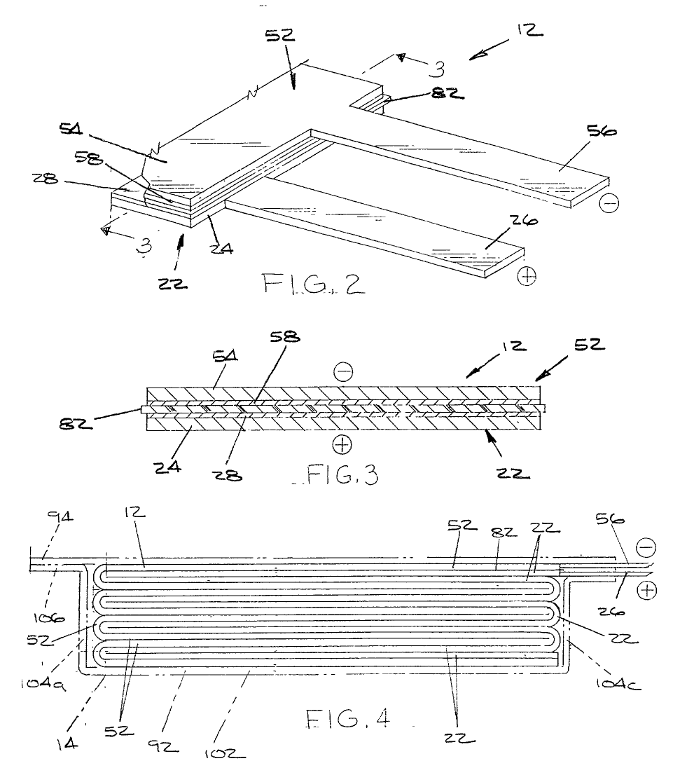

Referring now to the drawings wherein the showings are for the purpose of illustrating a preferred embodiment of the invention only, and not for the purpose of limiting same, the invention relates to a thin, lithium primary battery 10 and a method of forming the same. FIG. 1 is an exploded view of battery 10 illustrating a preferred embodiment of the present invention. Battery 10 is comprised of a battery cell 12 that is contained within a package 14. Battery cell 12, best seen in FIGS. 2 and 3, is comprised of a cathode section 22, an anode section 52 and a separator 82.

Cathode section 22 is basically an elongated strip, as best seen in FIG. 5. Cathode section 22 includes a layer 24 of metallic foil having a lead 26 extending from one end thereof, as best seen in FIG. 2. A cathode film 28 is disposed on layer 24, best seen in FIG. 5, but does not extend onto lead 26. Metallic foil layer 24 may be formed from copper, aluminum, nickel, stainless steel or similar conductive metals. In a preferred embodiment, layer 24 is formed of copper and has a thickness between 0.0005 inches (12.7 micron) and 0.003 inches (76.2 micron). Foil layer 24 may be formed from rolled copper foil or electrodeposited copper foil.

Broadly stated, cathode film 28 is comprised of a cathode material, a carbonaceous material, a polymer binder and a plasticizer. The cathode material for use in this invention can contain an active cathode material such as manganese dioxide (MnO₂), carbon monofluoride, vanadium pentoxide, metal oxide such as nickel oxide, lead oxide, or copper oxides; sulfides such as iron sulfides.

In a preferred embodiment, the cathode material is manganese dioxide (MnO₂). The manganese dioxide (MnO₂) preferably has a particle size that ranges from about 10 microns to about 30 microns, and an average particle size of about 20 microns to about 25 microns. The manganese dioxide (MnO₂) also preferably has a surface area of about 30 m²/g to about 50 m²/g, and more preferably about 40-45 m²/g. The manganese dioxide (MnO₂) preferably has a total porosity (N₂) of about 0.02 to about 0.08 ml/g, and more preferably, a total porosity (N₂) of about 0.04 to about 0.06

The carbonaceous material is preferably acetylene black or other carbon black materials.

The polymer binder may be comprised of PVDF or PVDF-HFP copolymers.

The plasticizer is selected from the group consisting of ethylene carbonate. In a preferred embodiment of the present invention, the plasticizer is formed of propylene carbonate (PC).

In a preferred embodiment, cathode film 28 is comprised of:

about 60% by weight to 80% by weight manganese dioxide;

about 5% by weight to 10% by weight carbon;

a polymer binder; and

a plasticizer.

Cathode section 22 shall now be further described with respect to a process for forming the same. FIG. 7 is a schematic view of a process 30 for forming cathode section 22. Cathode section 22 is formed from a generally continuous length of a metallic foil, preferably copper. FIG. 7 shows metallic foil layer 24 being fed along a path P₁ from a roll 32 of metal foil. Pairs of opposed pinch rollers 34 are operable to convey metallic foil from roll 32 along path P₁. A cathode film applicator 36, disposed along path P₁, contains a reservoir of the aforementioned cathode film material in fluid form. As pinch rollers 34 convey metallic foil layer 24 from roll 32 along path P₁, cathode film applicator 36 is operable to apply a layer 40 of a cathode film material 38 onto the surface of foil layer 24. Foil layer 24 with layer 38 of cathode film material thereon passes under a dryer 42 as metallic foil layer 24 moves along path P₁. Dryer 42 is operable to dry the fluid cathode material thereby forming cathode film 28 on metallic foil layer 24. Applicator 36 is controlled such that a portion 24a, shown in phantom in FIG. 5, of the leading edge of metallic foil layer 24 is not coated with cathode film material 38. A cutting device 44 is provided to cut the leading edge of cathode section 22. By a stamping or cutting operation, the end of cathode section 22 is cut, or otherwise formed, to define lead 26 from portion 24a of metallic layer 24. FIG. 5 is a generally top plan view of cathode section 22 showing lead 26 formed at the end thereof.

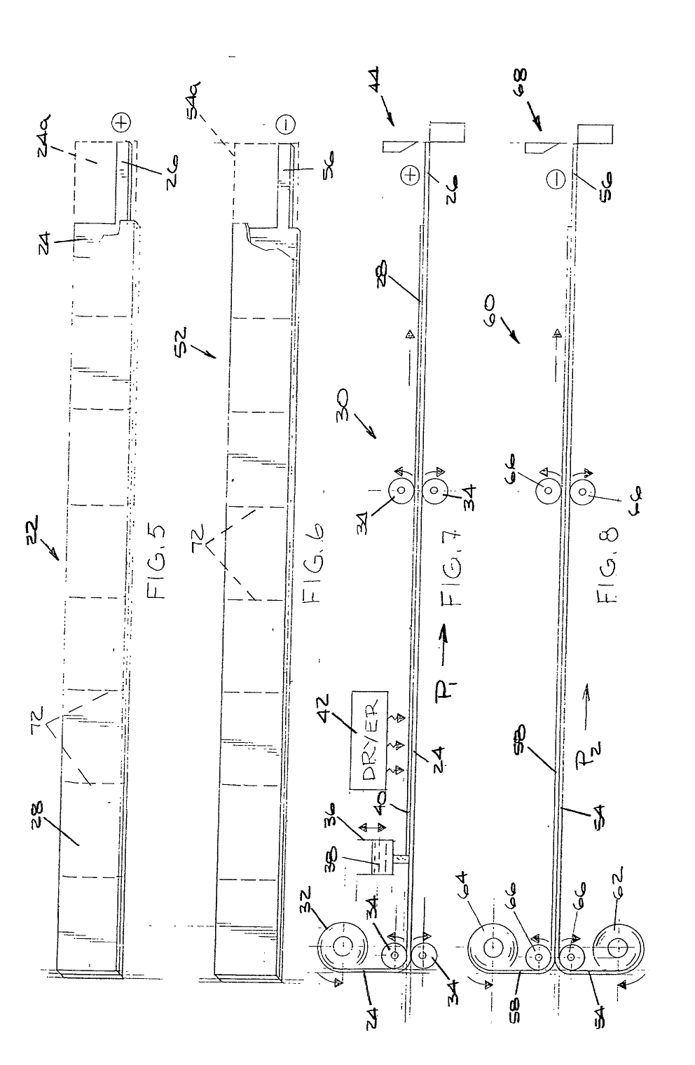

Referring now to FIGS. 6 and 8, anode section 52 shall now be described. Anode section 52 is basically an elongated strip, as best seen in FIG. 6. Anode section 52 includes an elongated metallic foil layer 54 having a lead 56 extending from one end thereof, as best seen in FIG. 2. A layer of lithium foil 58 is applied onto elongated metallic foil layer 54. Lithium foil 58 does not extend onto lead 56. Metallic foil layer 54 is formed of a metal foil, as previously described with respect to metallic layer 24. Metallic foil layer 54 is preferably formed of aluminum or copper and has a thickness similar to metallic foil layer 24.

Lithium foil 58 preferably has the following thickness: 100 μm to 300 μm (0.1 to 0.3 mm).

Anode section 52 is formed by cold rolling metallic foil layer 54 with lithium foil 58. FIG. 8 is a schematic view of a process 60 for forming anode section 52. Metallic foil layer 54 is fed along path P₂ from a generally continuous roll 62. Similarly, lithium foil 58 is provided from a roll 64. The respective foils 54, 58 are forced together and driven along path P₂ by a plurality of spaced-apart, interacting pinch rollers 66. A portion 54a of foil layer 54 is not covered by lithium foil 58. A cutting device 68 forms anode lead 56 from portion 54a of foil layer 54. FIG. 6 is a top plan view of anode section 52.

As indicated above, cathode section 22 and anode section 52 are spaced-apart by a separator 82. Separator 82 is formed of a micro-porous material to allow electrolyte in an electrolytic material to penetrate therethrough and into contact with lithium foil 58 of anode section 52. Separator 82 may be formed of polyethylene, polypropylene or the like. In a preferred embodiment, separator layer 82 is a micro-porous polypropylene. As best seen in FIGS. 2 and 3, cathode section 22 and anode section 52 are joined together with separator layer 82 disposed therebetween. As shown in FIG. 2, leads 26, 56 are spaced apart and offset when cathode section 22 is joined with anode section 52. Cathode section 22 and anode section 52 are joined with cathode film 28 and lithium foil 58 engaging separator 82. Together, cathode section 22, anode section 52 and separator 82 form battery cell 12. As shown in the drawings, battery cell 12 is an elongated, strip-like structure.

Referring now to FIG. 1, in the embodiment shown, package 14 is comprised of a lower package section 92 and an upper package section 94. Package section 92 is dimensioned to contain battery assembly 12 in a hermetically sealed fashion and to have cathode and anode leads 26, 56 extending outwardly through package 14. In accordance with the present invention, package 14 is formed of a laminate material. The laminate sheet is generally comprised of a metallic foil layer disposed between two polymeric adhesive layers. (The specific polymeric adhesive layers and metallic foil layer are not shown in the drawings). In a preferred embodiment, the laminate sheet is comprised of an inner, aluminum layer and outer layers of polypropylene (PP) or polyethylene (PE). The overall thickness of the laminate is typically between 0.10 mm and 0.15 mm.

In the embodiment shown, the laminate sheet has a generally rectangular shape and is used to form lower package section 92. A generally rectangular cavity 98 is formed in the laminate sheet. Cavity 98 may be formed by conventional forming means, such as a stamping process or a molding process. Cavity 98 has a bottom wall 102 and four side walls, designated 104a, 104b, 104c and 104d, that define an opening dimensioned to receive battery assembly 12. Cavity 98 is disposed within laminate sheet 96 such that a generally U-shaped flange 106 (as seen in FIG. 1) is formed around cavity 98 and extends therearound. Cavity 98 is dimensioned to receive battery assembly 12 therein, with cathode and anode leads 26, 56 extending over flange 106.

Upper package section 94 is also formed from a sheet of the laminate material heretofore described. Upper package section 94 is dimensioned to be positioned over lower package section 92 so as to cover cavity 98 and overlay flange 106 and cathode and anode leads 26, 56, as best seen in FIG. 1.

Battery cell 12 is adapted to be received within cavity 98 in lower package section 92. In the embodiment shown, battery cell 12 is folded in an accordion fashion, as best seen in FIG. 1, so as to fit within cavity 98. By folding battery cell 12 in an accordion fashion, cathode section 22 is folded onto itself, and likewise anode section 52 is folded onto itself. FIGS. 5 and 6 illustrate fold lines 72 in phantom, where cathode section 22 and anode section 52 are folded. With battery cell 12 disposed within cavity 98, leads 26, 56 extend beyond flange 106 of lower package section 92. Battery cell 12 may also be shaped to fit within cavity 98 by wrapping battery cell 12 around a thin, rectangular-forming mandrel (not shown) to form a rectangular structure.

With battery cell 12 within cavity 98 defined in lower package section 92, an electrolyte (not shown) is added to cavity 98. The electrolyte material is comprised of ethylene carbonate (EC), propylene carbonate (PC) and triflate salt. A preferred composition of the electrolyte would be as follows:

about 10% by weight to 60% by weight ethylene carbonate;

about 40% by weight to 90% by weight propylene carbonate; and

about 0.5 to 1.5 moles triflate salt (LiCF₃SO₃).

A more preferred composition of electrolyte would be:

about 15% by weight to 50% by weight ethylene carbonate;

about 50% by weight to 85% by weight propylene carbonate; and

about 0.8 to 1.2 moles triflate salt (LiCF₃SO₃).

After the electrolyte has been added to cavity 98, upper package section 94 is placed over lower package section 92 onto flange 106. With flange 106 in contact with the peripheral edges of upper package section 94, sufficient heat and pressure are applied to the peripheral edges of lower and upper package sections 92, 94 to cause the contacting polymer layers of the laminate sheets forming upper and lower package sections 92, 94 to soften and bond together to hermetically seal battery cell 12 within package 14.

The present invention thus provides a primary battery and a method of forming the same, wherein a prismatic primary lithium cell is formed, placed and sealed in a thin, flexible, metal laminate package.

Further, in the construction of the battery, a thin plastic cathode film is used which contains as a plasticizer one of the solvents of the electrolyte mix.

The foregoing description is a specific embodiment of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

Having described the invention, the following is claimed:

1. A primary lithium battery, comprised of:
a battery package formed from a thin metal/polymer laminate;
a single, elongated battery cell having a cathode section, an anode section and a separator disposed between said cathode section and said anode section, said cathode section including a copper foil having a cathode film thereon, said film including manganese dioxide, carbon, a polymer binder and a plasticizer selected from the group consisting of ethylene carbonate (EC) and propylene carbonate (PC), and said anode section including a copper foil having a lithium foil thereon.
an electrolyte including ethylene carbonate (EC) and propylene carbonate (PC) within said battery package.

2. A primary lithium battery as defined in claim 1, wherein said battery package includes a first section having a cavity formed therein and a second section, said cavity dimensioned to receive said battery cell and said second section dimensioned to seal said battery cell within said cavity.

3. A primary lithium battery as defined in claim 2, wherein said battery package is formed from a laminate material having two polymer layers and a metallic layer disposed between said two polymer layers.

4. A primary lithium battery as defined in claim 1, wherein said cathode film is coated on said copper foil.

5. A primary lithium battery as defined in claim 1, wherein said lithium foil is cold rolled onto said copper foil.

6. A primary lithium battery as defined in claim 1, wherein said battery is folded in an accordion fashion, or wound in a prismatic format, within said battery package.

7. A method of forming a primary lithium battery, comprising the steps of:
forming an elongated, rectangular battery cell strip having leads extending therefrom by joining an elongated strip of a cathode section to an elongated anode section with an elongated sheet of separator material disposed therebetween, said cathode section comprised of a metallic foil having a cathode film thereon;
folding said battery cell strips in an accordion fashion to form a generally rectangular structure;
inserting said folded battery cell into a rectangular cavity formed in a first sheet of laminate material with said battery leads extending from said cavity;
covering said battery and cavity with a second sheet of said laminate material; and
sealing the edges of said first and second sheets of laminate material to encase said battery within said cavity.

8. A method of forming a primary lithium battery as defined in claim 7, wherein said first and second laminate materials include a metal foil disposed between two polymer sheets.

9. A method of forming a primary lithium battery as defined in claim 7, wherein said cathode film includes a plasticizer consisting of propylene carbonate (PC).

10. A method of forming a primary lithium battery as defined in claim 7, wherein said battery includes an electrolyte including ethylene carbonate (EC), propylene carbonate (PC) and a lithium salt.

11. A method of forming a primary lithium battery as defined in claim 7, wherein said anode section is comprised of copper foil and lithium foil.
